(19) United States
(12) Patent Application Publication
(10) Pub. No.: US 2012/0261468 A1
(43) Pub. Date: Oct. 18, 2012

(54) SYSTEM AND METHOD FOR PROVIDING VERIFICATION OF AGE OR OTHER ATTRIBUTES IN AN ALCOHOL SERVING ENVIRONMENT

(76) Inventors: Thomas Colucci Hecht, Arlington, VA (US); Tedd Lee, Brookline, MA (US)

(21) Appl. No.: 13/443,910

(22) Filed: Apr. 11, 2012

Related U.S. Application Data
(60) Provisional application No. 61/475,623, filed on Apr. 14, 2011.

(51) Int. Cl. G06K 5/00

(52) U.S. Cl. 235/381; 235/380

(57) ABSTRACT

The present invention generally relates to an age, identity and other attribute verification system. Specifically, this invention relates to a system and method for providing a verification system and method for use, primarily, at locations and venues serving alcoholic beverages.

### FIELD OF THE INVENTION

The present invention generally relates to an age, identity and other attribute verification system. Specifically, this invention relates to a system and method for providing verification of age and other attributes of individuals, primarily at locations and venues serving alcoholic beverages.

### CROSS-REFERENCE TO RELATED APPLICATIONS

This application claims the benefit of the following provisional applications, each of which is hereby incorporated by reference in its entirety: U.S. Pat. App. No. 61/475,623 filed on Apr. 14, 2011 and entitled “SYSTEM AND METHOD FOR PROVIDING VERIFICATION OF AGE OR OTHER ATTRIBUTES IN AN ALCOHOL SERVING ENVIRONMENT.”

### BACKGROUND

Automated systems are becoming ubiquitous in use and deployment. From checkout counters at grocery stores and other retail outlets to the provision of services (e.g., car washes, gas stations), automated systems are becoming the norm to both reduce cost and increase efficiencies. While some industries have flourished in this space, other industries have noticeably been left without automated systems.

With respect to alcohol serving establishments, there is a noticeable lack of automated systems. One reason for this is that it is a highly regulated industry with underage consumers constantly trying to trick or otherwise defeat security measures set in place to keep practices in line with these regulations.

Since individuals are constantly trying to defeat these systems, it has generally been believed that manual checking of identification and other characteristics is the best route to confirming compliance with these regulations. As such, alcohol service establishments have been forced to endure the higher costs and lowered efficiencies of using manual methods to confirm age verification and other attributes of individuals and patrons.

Therefore, there is need in the art for a system and method for providing verification of age or other attributes in an alcohol serving environment. These and other features and advantages of the present invention will be explained and will become obvious to one skilled in the art through the summary of the invention that follows.

### SUMMARY OF THE INVENTION

Accordingly, it is an aspect of the present invention to provide a system and method for providing verification of age or other attributes in an alcohol serving environment.

According to an embodiment of the present invention, a system for providing verification of attributes in an alcohol serving environment includes: one or more verification units, wherein each of said one or more verification units comprises an identification component, wherein said identification component comprises verification data regarding one or more individuals; and one or more reader units, wherein each of said one or more reader units configured to read said identification component of said one or more verification units.

According to an embodiment of the present invention, each of said one or more verification units further comprises an affixing component.

According to an embodiment of the present invention, each of said one or more verification units further comprises a portable component.

According to an embodiment of the present invention, the one or more of said one or more reader units are handheld units configured to be operated by individuals.

According to an embodiment of the present invention, the one or more of said one or more reader units are automated reader units.

According to an embodiment of the present invention, the one or more automated reader units are configured to read and process said identification components of said one or more verification units without individual operation.

According to an embodiment of the present invention, the one or more automated reader units are configured to read and process said identification components of said one or more verification units without individual operation.

According to an embodiment of the present invention, the system may further include a drink providing component configured to automatically mix beverages and provide said beverages to individuals verified by one or more of said one or more reader units.

According to an embodiment of the present invention, the verification units may be configured to be utilized with inventory control methods.

According to an embodiment of the present invention, the system may further include a printing component configured to print a receipt.

According to an embodiment of the present invention, the system may further include a payment component configured to accept one or more payment means.

According to an embodiment of the present invention, a method for providing verification of attributes in an alcohol serving environment includes the steps of: encoding an identification component of a verification unit with verification data; distributing said verification unit to a user; reading said identification component of said verification unit with a reader unit; process a transaction request from said user; verifying said transaction request from said user at said reader unit based at least in part on said verification data encoded in said identification component; and effecting said transaction request.

According to an embodiment of the present invention, the effecting of said transaction request comprises providing an automatically mixed beverage to said user via a drink providing component.

According to an embodiment of the present invention, the effecting of said transaction request comprises providing inventory control.

According to an embodiment of the present invention, the effecting of said transaction request comprises providing a receipt to said user via a receipt printing component.

According to an embodiment of the present invention, the effecting of said transaction request comprises receiving payment from said user via a payment component configured to accept one or more payment means.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention; and

FIG. 3 is a flowchart of an exemplary method in accordance with an embodiment of the present invention.

### DETAILED SPECIFICATION

The present invention generally relates to an age, identity and other attribute verification system. Specifically, this invention relates to a system and method for providing a verification system and method for use, primarily, at locations and venues serving alcoholic beverages.

According to an embodiment of the present invention, the system and method is accomplished through the use of a combination of verification units and reader units. Verification units may be comprised of one or more of a affixing or portable component and an identification component. Verification units may include, but are not limited to, wristbands, hand stamps, sticky labels and identification cards. In an exemplary embodiment a verification unit may be a disposable wristband with a barcode that contains relevant information about the wearer of the wristband. One of ordinary skill in the art would appreciate that there are numerous verification units that may be utilized with embodiments of the present invention, and embodiments of the present invention are contemplated for use with any verification unit.

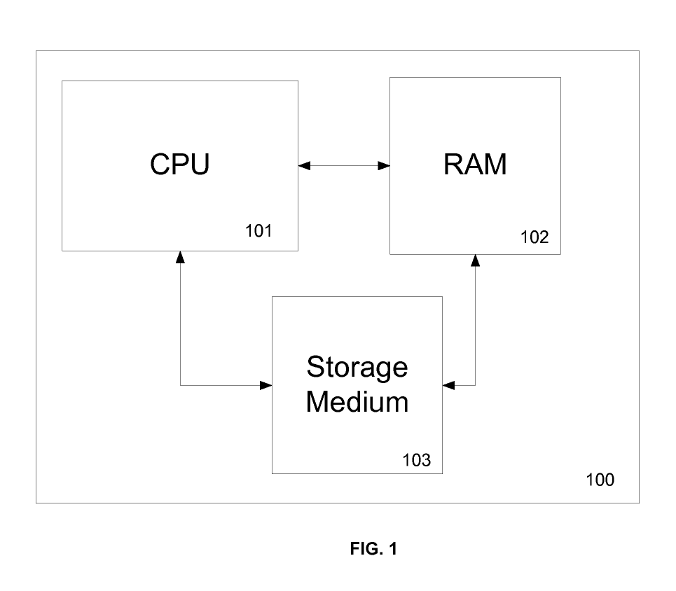

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

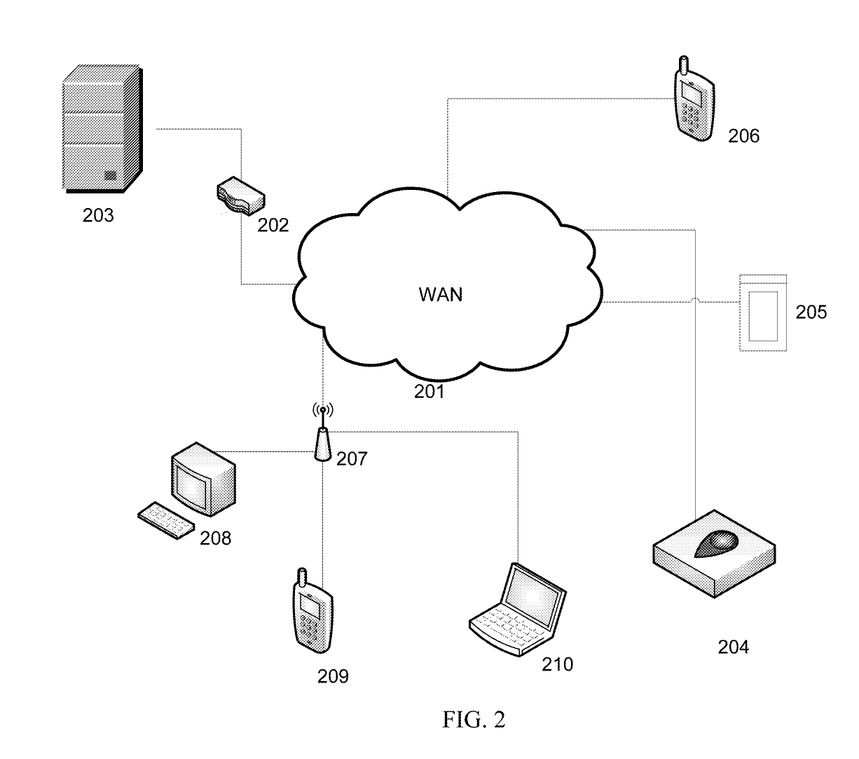

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 206 directly connected to the WAN 201, ii) through a computing device 208, 209, 210 connected to a wireless access point 207 or iv) through a reader unit 204, 205, 206 (i.e., reader unit comprised of software applications present on a mobile computing device such as a smartphone) via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an exemplary embodiment of the present invention, the reader unit may be a handheld scanner with the ability to read verification units and display to the operator of the reader unit, the pertinent information related to the verification unit. In other embodiments, the reader unit may not require an operator, as the functionality may be fully automated.

### Exemplary Embodiments

Embodiments of the present invention may be utilized to verify any number of relevant points of interest in an alcohol serving establishment. For instance, the verification unit and reader unit combination may be utilized to monitor the occupancy of an establishment. Verification units may be given to each patron upon entry and either retrieved or disabled upon the departure of the patron. A centralized processing unit may receive data from one or more scanners and keep a running count of how many patrons are present in the establishment as well as other related information (e.g., total number of patrons for a given date/time range, average age)

According to an alternative embodiment of the present invention, a reader unit could be used without a verification unit in order to confirm or monitor occupancy of an establishment. For instance, a reader unit could be comprised of a pair of laser beams (laser 1 and laser 2) or other passable barriers. In this embodiment, when a person crosses laser 1 first and then subsequently crosses laser 2, the reader unit could record an entrance event, increasing the total occupancy count of the establishment by 1. Following from the previous example, if a person first crossed laser 2 and then subsequently crossed laser 1, the reader unit would register an exit event, decreasing the total occupancy count of the establishment by 1. One of ordinary skill in the art would appreciate there are numerous ways to record or register entry or exit events, and embodiments of the present invention are contemplated for use with any method of recording or registering an entry or exit event.

According to an embodiment of the present invention, the verification unit and reader unit combination may be utilized to monitor cigarette breaks or other situations where a patron may be entitled to leave an establishment for a limited amount of time. In this manner, a verification unit may be read by a reader unit upon exit of the establishment for one or more identified purposes. The reader unit may then start a countdown in relation to the particular identified purpose. For instance, a patron may be given 10 minutes to smoke a cigarette and return before their verification unit expires and the patron would be required to repurchase and revalidate their entrance into the establishment. This may be used, for instance, to prevent bar hopping or other undesirable activities associated with certain patrons.

According to an embodiment of the present invention, the verification unit and reader unit combination may be utilized to identify patrons above a certain age required to purchase alcoholic beverages (e.g., over 21 years of age). In this manner, establishments that allow individuals of drinking age and non-drinking age may be provided additional methods to verify the appropriateness in serving a particular individual. For example, each time a user wishes to order a drink, he may have to have his verification unit read by a reader unit. In an exemplary embodiment of the present invention, the reader unit may be further configured to have scanned a photo ID of the patron upon entry into the establishment. This photo ID would then appear on the display unit of the reader unit, allowing the system or user of the reader unit to confirm the identity of the patron by the stored photo ID picture.

According to an embodiment of the present invention, the reader unit may be further comprised of a ordering component. In this manner, a reader unit may allow one or more patrons to place an order at a reader unit. The ordering component may be further configured to allow one or more patrons to open a tab and allow one or more other patrons to be allowed to place drinks on their tab. In this manner, a person may open a tab, for example, with a credit card, and allow their friends to place drinks orders to be charged on their tab. The verification units of the friends may be scanned by the reader unit to confirm they are allowed on the person's tab. Alternatively, the reader unit may be configured to print out or otherwise provide additional verification units to the friends of said person to confirm the identity of the friends with the system and methods herein described. Additional safety measures may be utilized with this system and method, such as requiring a pin number to be entered whenever a drink is to be placed on a patron's tab, and set beverage limit, this could also be implemented by the serving institution or event.

According to an embodiment of the present invention, the reader unit may be further comprised of a drink providing component. In this manner, an automated liquor mixing and providing component may be utilized, helping to reduce the overall workload of any bartenders or servers present. In one embodiment, the liquor mixing and providing component may be accessed directly accessed by a patron, and the patron would receive their choice of alcoholic or non-alcoholic beverage from said liquor mixing and providing component. In another embodiment, the order may be placed at the reader unit, said order to be received and prepared remotely and later delivered to the patron by a server, bartender or other person at the establishment.

According to an embodiment of the present invention, the verification units may be utilized with non-patron elements. For instance, the verification units may be utilized with inventory control methods. In this manner, a verification unit may be present on each bottle or other beverage container. When a beverage is served or a drink created, the verification unit may be scanned and the item or portion of the item consumed can be recorded, thereby allowing accurate inventory control. This will allow for establishments to better track their inventories. Additionally, automated ordering systems and methods may be utilized to automatically order additional inventory when certain stocks run below a desired level.

According to an embodiment of the present invention, the reader unit may be further comprised of a printing component. In this manner, a patron may utilize the reader unit to receive a receipt of one or more transactions occurring through the systems and methods herein described. The printing component may be located at the reader unit itself or remotely located. In this manner, the receipt may be printed directly into the possession of the patron or brought to the patron by a bartender, server or other person at the establishment.

According to an embodiment of the present invention, the reader unit may be further comprised of a payment component. In this manner, the reader unit may allow for the patron to pay for an order or setup a tab at the reader unit. One of ordinary skill in the art would appreciate that there are numerous methods for receiving payment at a reader unit, and embodiments of the present invention are contemplated for use with any method of receiving payment. Where cash payments are received by the reader unit, change may be provided to the patron directly, or via a printed receipt that may be redeemed at an appropriate place (e.g., the bar, the coat check).

According to an embodiment of the present invention, the data received from the scanning of verification units may be utilized to perform detailed analytics on numerous aspects occurring at an establishment. For instance, inventory analytics, patron analytics (e.g., based on time, day, age, gender) and employee analytics (e.g., which servers or employees performed the most recorded actions) and other analytics may be utilized individually or in any combination to help an establishment adapt to the historical data.

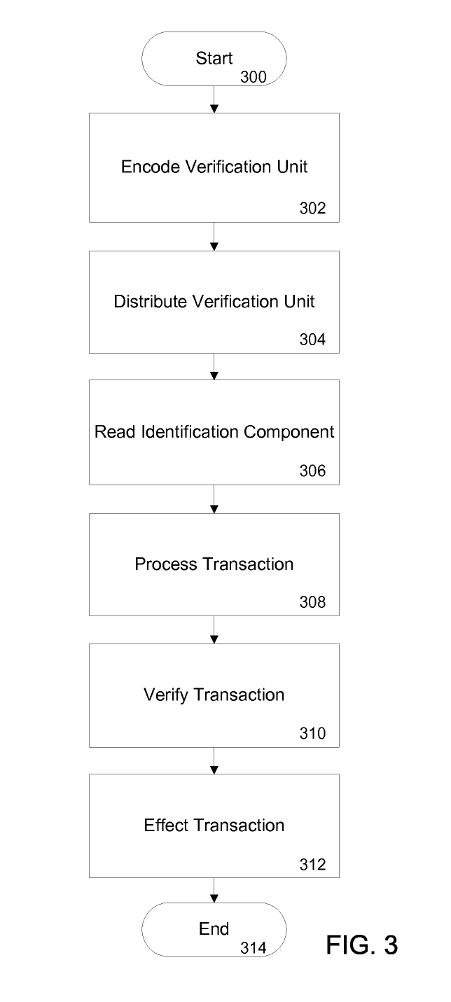

Turning now to FIG. 3, an exemplary method, in accordance with an embodiment of the present invention is shown. The process starts at step 300. At step 302, an individual's information is verified and the a verification unit comprising data related to the individual (e.g., age, payment means, appearance, gender, preferences) is encoded with the data.

At step 304, the verification unit is distributed to the individual. This may be done by way of printing out a unique wristband or other item for the individual to keep with them and utilize during their time at the particular alcohol serving establishment.

At step 306, the individual wishes to interact with one or more components of the system (e.g., automated drink ordering, automated payment, entrance into a VIP area). At this point, the individual provides the verification unit for reading by a reader unit associated with the component to be interacted with. The reader unit receives the data stored in relation to the verification unit.

At step 308, the reader unit processes the requested transaction presented by the individual in possession of the verification unit. For instance, if the individual in possession of a verification unit is attempting to order a drink from a drink providing component, the reader unit, in conjunction with the drink providing component may first verify that the request is one that is capable of being processed at the particular unit (e.g., confirm quantities of required beverage components). If the transaction is one that could be appropriately served by the reader unit, the process proceeds to step 310, whereby the reader unit confirms the individual and the related verification unit have the necessary permissions to effect the transaction (e.g., appropriate age, enough funds to complete transaction, appropriate permissions, verification unit is valid).

Assuming the reader unit verifies the transaction successfully in step 310, the process moves to step 312, whereby the transaction is enacted. In the example of a drink order, the automated drink providing component may begin to dispense the drink requested by the individual. At step 314, the process ends.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing verification of attributes in an alcohol serving environment, the system comprising:
one or more verification units,
wherein each of said one or more verification units comprises an identification component,
wherein said identification component comprises verification data regarding one or more individuals; and
one or more reader units,
wherein each of said one or more reader units configured to read said identification component of said one or more verification units.

2. The system of claim 1, wherein each of said one or more verification units further comprises an affixing component.

3. The system of claim 1, wherein each of said one or more verification units further comprises a portable component.

4. The system of claim 1, wherein one or more of said one or more reader units are handheld units configured to be operated by individuals.

5. The system of claim 1, wherein one or more of said one or more reader units are automated reader units.

6. The system of claim 5, wherein said one or more automated reader units are configured to read and process said identification components of said one or more verification units without individual operation.

7. The system of claim 5, wherein said one or more automated reader units are configured to read and process said identification components of said one or more verification units without individual operation.

8. The system of claim 1, further comprising a drink providing component configured to automatically mix beverages and provide said beverages to individuals verified by one or more of said one or more reader units.

9. The system of claim 1, wherein said verification units may be configured to be utilized with inventory control methods.

10. The system of claim 1, further comprising a printing component configured to print a receipt.

11. The system of claim 1, further comprising a payment component configured to accept one or more payment means.

12. A method for providing verification of attributes in an alcohol serving environment, the method comprising the steps of:
encoding an identification component of a verification unit with verification data;
distributing said verification unit to a user;
reading said identification component of said verification unit with a reader unit;
process a transaction request from said user;
verifying said transaction request from said user at said reader unit based at least in part on said verification data encoded in said identification component; and
effecting said transaction request.

13. The method of claim 12, wherein the effecting of said transaction request comprises providing an automatically mixed beverage to said user via a drink providing component.

14. The method of claim 12, wherein the effecting of said transaction request comprises providing inventory control.

15. The method of claim 12, wherein the effecting of said transaction request comprises providing a receipt to said user via a receipt printing component.

16. The method of claim 12, wherein the effecting of said transaction request comprises receiving payment from said user via a payment component configured to accept one or more payment means.
